(19) United States
(12) Patent Application Publication
(10) Pub. No.: US 2017/0329905 A1
(43) Pub. Date: Nov. 16, 2017

(54) Life-Long Physiology Model for the Holistic Management of Health of Individuals

(71) Applicant: Siemens Healthcare GmbH, Erlangen (DE)

(72) Inventors: Tiziano Passerini, Plainsboro, NJ (US); Tommaso Mansi, Plainsboro, NJ (US); Dorin Comaniciu, Princeton Junction, NJ (US)

(21) Appl. No.: 15/594,081

(22) Filed: May 12, 2017

Related U.S. Application Data
(60) Provisional application No. 62/335,444, filed on May 12, 2016.

(51) Int. Cl. G06F 19/00; G06N 5/04; G06N 99/00

(52) U.S. Cl. CPC G06F 19/322; G06N 99/005; G06F 19/3437; G06N 5/04

(57) ABSTRACT

A method and system for intelligent automated holistic health management of an individual is disclosed. Medical data for the individual is acquired. A computational lifelong physiology model of the individual is updated based on the acquired medical data. A current health state of the individual is determined using the updated lifelong physiology model of the individual. A holistic health management plan for the individual is generated based on the current health state of the individual using a trained intelligent artificial agent.

This application claims the benefit of U.S. Provisional Application No. 62/335,444, filed May 12, 2016, the disclosure of which is herein incorporated by reference.

### BACKGROUND OF THE INVENTION

The present invention relates to a life-long physiology model for holistic management of the health of individuals, and more particularly, to computer based intelligent monitoring and management of an individual's health using a life-long physiology model.

Optimal management of the overall health of an individual is a complex problem that requires the integration of data from multiple, heterogeneous sources. For example, in addition to measurements of many different types of health parameters, a continuously evolving knowledge of human physiology and pathology and of best medical practices in various different medical specialties would also be needed for optimal management of the overall health of an individual. The healthcare system, in its traditional form and structure, does not support this kind of individual-centric, life-long health management. Healthcare providers current act as on-demand service providers, and therefore are only involved in a relatively narrow portion of the continuum of care for an individual. There is currently no system or single point of reference for the holistic management of the health of an individual across the entire continuum of care.

### BRIEF SUMMARY OF THE INVENTION

The present invention provides a method and system for computer based intelligent holistic management of the health of an individual. Embodiments of the present invention utilize a lifelong physiology model for an individual that includes a collection of physiology models focusing on different aspects of the individual's physiology and pathology. The lifelong physiology model of the patient provides a comprehensive representation of the health state of the individual. Embodiments of the present invention also utilize a trained intelligent artificial agent that controls the use of the lifelong physiology model and defines and updates a holistic health management plan for the individual in order to maximize the length and quality of the individual's life.

In one embodiment of the present invention, medical data for the individual is acquired. A computational lifelong physiology model of the individual is updated based on the acquired medical data. A current health state of the individual is determined using the updated lifelong physiology model of the individual. A holistic health management plan for the individual is generated based on the current health state of the individual using a trained intelligent artificial agent.

These and other advantages of the invention will be apparent to those of ordinary skill in the art by reference to the following detailed description and the accompanying drawings.

### BRIEF DESCRIPTION OF THE DRAWINGS

FIG. 1 illustrates a system for holistic management of the health of an individual according to an embodiment of the present invention;

FIG. 2 illustrates a method of automated intelligent holistic management of the health of an individual according to an advantageous embodiment of the present invention;

FIG. 3 is a high-level block diagram of a computer capable of implementing the present invention; and

FIG. 4 illustrates a system for holistic management of the health of an individual on a mobile device according to an embodiment of the present invention.

### DETAILED DESCRIPTION

The present invention relates to a method and system for computer based intelligent holistic management of the health of an individual using a lifelong physiology model of the individual. Embodiments of the present invention described herein utilize various types of data, such as medical image data, sensor measurements, laboratory diagnostic data, and other types of medical information of an individual, in order to generate a comprehensive representation of a health state of an individual using the lifelong physiology model. Embodiments of the present invention manipulate digital representations of such data, and such manipulations are virtual manipulations accomplished in the memory or other circuitry/hardware of a computer system. Accordingly, is to be understood that embodiments of the present invention may be performed within one or more computer system using data stored within the computer system or data stored remotely and accessed by the computer system.

New trends in healthcare, such as web-driven simplification of access to sources of medical knowledge and the commoditization of basic health monitoring technologies, have led to very fast penetration of new players in the next generation health market. These include: retail (e.g., pharmacies, food and grocery stores, and delivery services) powered by mobile monitoring systems; health ecosystems, including patient health management systems, telemedicine systems, etc.; new solutions for self-driven assessment of health status and the selection of care/care providers based on big data, advanced diagnostics, and precision medicine; and consumer markers including social communities, engagement platforms, and exchange platforms. According to an advantageous aspect, embodiments of the present invention take advantage of the opportunity offered by this new context to access data from individuals at several points across the continuum of care, to achieve individualized, tracked, and continuous healthcare.

The holistic management of the health of an individual has a potentially disruptive impact on the war healthcare providers operate. There is a growing pressure on healthcare providers to demonstrate transparency, accountability, and efficacy of the provided care. This requires a stronger emphasis on evidence-based practice, streamlined and reproducible workflows, continuous performance monitoring, and engagement with patients across the continuum of care. There is a need for a paradigm shift of healthcare from procedure-centric to individual-centric. According to an advantageous aspect of the present invention, the structured access to individual health data from multiple points of contact in the continuum of care can enable a better stratification of the patient population and more precise tailoring of health management plans to the needs of the individuals.

Moreover, according to an advantageous aspect of the present invention, data and medical knowledge can be collected, shared, and analyzed at the population level for the optimal management of the healthcare system as a whole. In recent years, the concept of population health has gained prominence. Population health encompasses: the analysis of health outcomes, as measured by morbidity, mortality, and quality of life, and their distribution within a population; the analysis of health determinants, including medical care, socioeconomic status, and genetics, that influence the distribution of health outcomes; and the analysis of policies and interventions, at the social, environmental, and individual level, that impact the health determinants. A key observation making population health so compelling is the evident mismatch between factors that demonstrably make people healthy and the distribution of health related spending. According to a 2012 study by the Bipartisan Policy Center, healthy behaviors are the main determinants of the health state of the average American person (50%), with environmental and genetics contributing another 20% each, and access to health care trailing with a mere 10%. On the converse, medical services dominate the health-related spending of American people (88%), with spending aimed at promoting healthy behaviors only totaling 4% on average. This imbalance is triggering a major trend to revise spending and resource allocation in the healthcare system. In addition to a strategy for managing changes in the reimbursement model, healthcare organizations will also need a strategy to drive the change at the level of defining policies and interventions. Embodiments of the present invention utilize a computer-based intelligent artificial agent trained using machine learning based methods based on population data to determine policies and interventions to optimize the health outcomes of individuals.

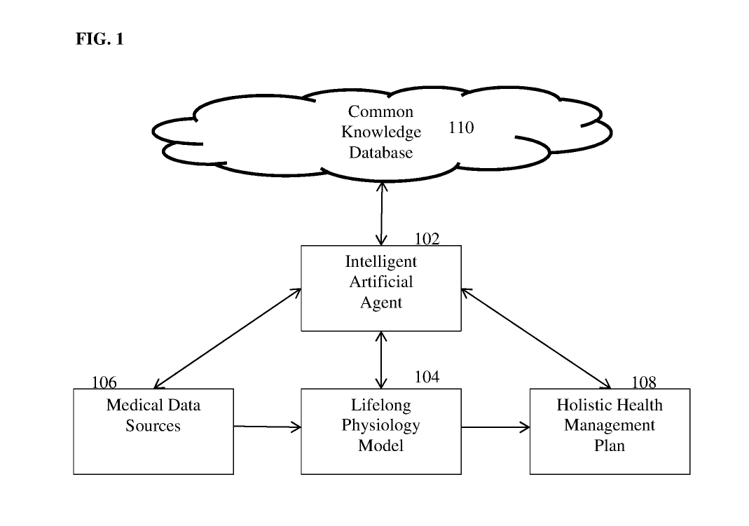

FIG. 1 illustrates a system for holistic management of the health of an individual according to an embodiment of the present invention. FIG. 1 shows a graphical representation of the system, and it is to be understood that various elements shown in FIG. 1, such as the lifelong physiology model 102 and the artificial agent 104, can be implemented as applications on one or more computer devices by one or more processors executing computer program instructions (code) defining operations of such applications. Various elements of the system shown in FIG. 1 can be stored and implemented on single computer device or stored and operated in various combinations on multiple different computer devices. The elements of the system shown in FIG. 1 can be stored and/or implemented on various types of computer devices, including but not limited to a mobile device (e.g., smart phone or tablet), personal computer, server device, client device, or cloud-based computing system.

The system of FIG. 1 provides a continuously evolving artificial intelligence based system for holistic management of the health of an individual. As shown in FIG. 1, the system includes a lifelong physiology model 102, also referred to herein as the “health avatar”, which provides real-time determination and visualization of the comprehensive health state of the individual. The terms “lifelong physiology model” and “health avatar” are used interchangeably herein. The lifelong physiology model 102 is continually updated with inputs from a system of medical data sources 106, such as sensors, medical devices, medical imaging acquisition devices, etc., in order to ensure the synchronization of the state of the lifelong physiology model 102 and the current state of the individual. Based on the predictions of the lifelong physiology model 102, a holistic health management plan 108 is generated to guide the actions of the individual. An intelligent artificial agent 104 manages operation of the health avatar 102, triggering requests for data to the system of medical data sources 106, querying the health avatar 102 for health parameters or markers of disease, and triggering the generation of the health management plan 108. The intelligent artificial agent 104 has access to a common knowledge database 110 where anonymized data of all connected individuals is stored, enabling comparative studies and information exchange.

The lifelong physiology model (“heath avatar”) 102 provides a comprehensive health state of the individual. The health avatar 102 is based on a priori knowledge and subject-specific medical data, such as anatomical data from medical images of the subject, physiological measurements of the subject, etc. This medical data is received from the system of medical data sources 106. The health avatar 102 is an evolutionary model that describes the history of the system (the human body) as a function of the model parameters and the interactions with the environment as recorded by medical data sources 106 (e.g., sensors, medical devices, image acquisition devices, etc.). The health avatar 102 computes a current health state of the individual at a current time point based on current observed/measured medical data acquired from the medical data sources 106, and the collection of health states computed at previous time points describes the health history of the individual.

The health avatar 102 could be implemented as a full replica of the human body, from its most basic constituents (DNA, cells, tissues) to its larger scale features (organs, body parts). However, this approach is computationally prohibitive and no comprehensive, fully detailed model of the human body is available at this time. In an advantageous embodiment of the present invention, the health avatar 102 is implemented as a collection of multiple physiology models, each focusing on different aspects of the individual physiology and pathology. For example, the lifelong physiology model 102 can include different physiology models corresponding to specific organs, specific tissues, and/or specific disease pathways. In an advantageous implementation, these physiology models can be coupled to characterize the complex functioning of organs or larger portions of the body. This coupling can be synchronous or asynchronous. That is, each component of a coupled model may be run independently or may be tightly integrated with the other coupled components.

In an exemplary embodiment, the individual physiological models of the lifelong physiology model 102 are computational models that simulate the function/operation of the specific anatomy represented by each model. For example, such computational models can simulate movement/mechanics, electrical signal propagation (electrophysiology), blood flow (hemodynamics), and/or disease progression in various organs and tissues of the subject. Each computational model can be based on a subject-specific anatomical model of the relevant anatomic structure, which can be extracted from medical image data (e.g., computed tomography (CT), magnetic resonance image (MRI), ultrasound, X-ray, DynaCT, positron emission tomography (PET), etc.) of the individual acquired using an image acquisition device (a medical data source 106). Each computational model can be personalized with subject specific model parameters based on medical imaged data and physiological measurements of the individual received from the medical data sources 106. For example, a given computational physiology model can be personalized using an inverse problem method, in which the model parameters are iteratively adjusted to minimize a difference between observed physiological measurements of the individual and computed physiological measurements resulting from the simulation using the physiology model. Alternatively, a given computational model can be personalized using a machine learning based method in which a trained machine learning model (e.g., support vector machine (SVM) regressor, deep learning architecture, etc.) directly predicts the patient-specific model parameters from anatomic and/or physiological measurements of the individual. In an alternative embodiment, instead of being implemented using a computational model, one or more of the physiology models of the lifelong physiology model 102 may be implemented using a data-driven machine learning based model that directly maps input medical data of the individual, such as anatomical measurements and physiological measurements, to one or more output values that characterize function, health state, and/or risk prediction of the relevant anatomy.

As an example, the health avatar 102 can include a model of the heart (a virtual heart) for the assessment of heart function and the risk of cardiac disease. The heart model can be implemented as a multi-scale, multi-physics model including different components that simulate the functionality of the organ at different length scales (from the cellular level, to the tissue and organ level), as described in U.S. Pat. No. 9,129,053, entitled “Method and System for Advanced Measurements Computation and Therapy Planning from Medical Data and Images Using a Multi-Physics Fluid-Solid Heart Model” and United States Publication No. 2014/0012558, entitled “System and Methods for Integrated and Predictive Analysis of Molecular, Imaging, and Clinical Data for Patient-Specific Management of Disease,” the disclosures of which are incorporated herein in their entirety by reference. The heart model provides a description of the health state of the organ by computing physiology parameters that are used in clinical practice for the assessment of heart function (e.g., stroke volume, ejection fraction, PV loop) based on the simulations performed using the heart model. The heart model can be calibrated to the current state of the individual through a personalization procedure that integrates available subject-specific data. For example, methods for personalizing the heart model are described in International Patent Publication No. WO 2015/153832 A1, entitled “System and Method for Characterization of Electrical Properties of the Heart from Medical Images and Body Surface Potentials,” United States Publication No. 2016/0210435, entitled “Systems and Methods for Estimating Physiological Heart Parameters from Medical Images and Clinical Data,” and U.S. Pat. No. 9,129,053, the disclosures of which are incorporated herein in their entirety by reference. The heart model can be used to visualize the effect of different therapy options, to plan the optimal strategy for therapy delivery, and also to predict the risk of adverse events based on the computed parameters, for example using the methods described in United States Publication No. 2013/0226542, entitled “Method and System for Fast Patient-Specific Cardiac Electrophysiology Simulations for Therapy Planning and Guidance” and United States Publication No. 2013/0197881, entitled “Method and System for Patient Specific Planning of Cardiac Therapies on Preoperative Clinical Data and Medical Images,” the disclosures of which are incorporated herein in their entirety by reference. The heart model can also be coupled with models of the circulatory system to study the blood flow dynamics in the body, or in specific organs or districts, as described in United States Publication No. 2016/0196384, entitled “Personalized Whole-Body Circulation in Medical Imaging,” the disclosure of which is incorporated herein in its entirety by reference. This can be useful to assess the health state of the blood vessels, including for example assessment of the presence and state of vascular diseases, such as aneurysm, atherosclerosis, etc. In addition to the heart model, the health avatar 102 may also include a plurality of other computational models corresponding to other specific organs, tissues, and/or disease pathways, and these models can be implemented similarly to the heart model described above. Similar to the heart model, the physiology models for other organs or tissues can characterize a current health state of the corresponding organ/tissue by computing relevant physiological parameters used to asses the organ/tissue based on simulations performed using the model.

The health avatar 102 can perform simulations to predict the response of the individual to events including disease events (e.g., cerebral aneurysm burst, or trauma) and therapeutic interventions (e.g., surgical, nonsurgical, pharmaceutical). As such, the health avatar 102 can be used to select the best treatment option in response to an adverse event or the best prevention strategy before an adverse event occurs.

The medical data sources 106 can include sensors and medical equipment (e.g., stethoscope, blood pressure meter, etc.) for acquiring physiological measurements of the individual. The medical data sources 106 can also include various medical image acquisition devices (medical imaging scanners) for acquiring medical images of the individual. The medical data sources can also include laboratory diagnostics. For example, the medical data of the individual sent to the health avatar 102 can include biochemical signals as produced by blood tests and/or molecular measurements (“omics”, e.g., proteomics, transcriptomics, genomics, metabolomics, lipidomics, and epigenomics). The medical data sources can also include medical reports for the collection of patient symptoms, clinical history, and any other available medical data. The medical data sources 106 can also include non-medical grade sensor devices (including wearable sensors) for acquiring measurements of physiological signals.

The data input from the medical data sources 106 can span a wide range of biometrics signals, and can be driven by the individual as in the Quantified Self movement, promoting self-monitoring and self-sensing through wearable sensors and wearable computing. In a possible embodiment, the individual may wear a wearable sensor network, such as a wearable wireless body area network (BAN), which is used to acquire physiological measurements. For example, the wearable sensor network can include a heart rate sensor, one or more blood pressure sensors, an ECG sensor, and a pulse oximeter. The wearable sensor network may also include sensors for individual's breathing, brain activity (e.g., electroencephalography (EEG)), electromyography (EMG), skin temperature, skin conductance, electrooculography (EOG), blood pH, glucose levels, etc. The wearable sensor network may be used to acquire continuous physiological measurements of the individual, which can then be transmitted wirelessly to the device on which the lifelong physiology model 102 is running.

Medical data of the individual can be automatically acquired from one or more of the medical data sources 106 continuously or at specified time intervals. Medical data of the individual can also be acquired from one or more of the medical data sources 106 in response to a request for the medical data triggered by the intelligent artificial agent 104. Medical data of the individual can also be acquired from one or more of the medical data sources 104 in response to a specific medical data acquisition event, such as when medical images of the subject are acquired, or laboratory diagnostic data is received. When new subject-specific medical data for the individual is acquired, the lifelong physiology model (health avatar) 102 is updated to match the current measured/observed medical data. The health avatar 102 can be updated by adjusting parameters of one or more of the individual physiological models based on the newly acquired medical data using the personalization procedure. The update of the health avatar 102 can be managed by the intelligent artificial agent 104. The updated health avatar 102 is then used to compute the current health state for the individual by performing simulations using the updated physiology models and computing physiological parameters based on the simulations.

The holistic health management plan 108 is generated by the intelligent artificial agent 104 using the lifelong physiology model 102. The holistic health management plan 108 is a plan that focuses on maximizing/optimizing health outcomes, including mortality, morbidity, and quality of life, for the individual given the current health state of the individual. The holistic health management plan 108 includes directives for optimization of the health status of the individual. These directives can include directives on consultations with medical professional (e.g., directives to consult with a particular type of medical profession or a specific medical professional), suggested over the counter medications for the individual to take, dietary recommendations tailored to the individual, as well as a training plan selected or defined for the individual. The holistic health management plan 108 can also include optimal planning of diagnostic (imaging or non-imaging based) tests, and more in general, the planning of an optimal therapy (e.g., drug intake).

The holistic health management plan 108 can be focused on specific issues or topics (e.g., reduction of the cardiovascular disease risk factors predicted using the health avatar 102), or on more general health targets, such as length and quality of life. Based on the parameters computed by the health avatar 102, the holistic health management plan 108 can include estimates of the risk of one or more adverse (disease) events, as well as the predicted risk reduction associated with the suggested course of action.

The common knowledge database 110 can be implemented as a cloud-based database accessible by the intelligent artificial agent via a data network, such as the Internet. The common knowledge database 110 stores data from a number of health avatars corresponding to a number of different individuals. For example, the data from the various health avatars can be stored in the common knowledge database 110 in the form of events. An event can be defined as the acquisition of new medical data from one or more medical data sources, which triggers an update of the health avatar 102 and correspondingly an update of the holistic health management plan 108. For each event for a given individual, the acquired medical data, the updated health parameters (health state) from the health avatar 102, and the updated holistic health management plan 108 can all be stored in the common knowledge database 110. This event data can be stored for each of a population of individuals. Long term outcomes are also captured and stored in the common knowledge database 110 for the various individuals so that populations studies on the effect of the health management plan can be performed using the population data stored in the common knowledge database 110. According to an advantageous implementation, the data for each individual is anonymized prior to being stored in the common knowledge database 110 by removing any identifying information of the specific individual. This allows the anonymized data stored in the common knowledge database 110 to be used for population studies and training the intelligent artificial agent 104, without violating privacy concerns for the specific individuals.

The intelligent artificial agent 104 is implemented on one or more computers or processors by executing computer program instructions (code) loaded into memory. The intelligent artificial agent 104 is an application/program that applies artificial intelligence to observe the health states of the individual and autonomously define and update the holistic health management plan 108 to achieve optimal health outcomes for the individual. The intelligent artificial agent 104 controls the use of the health avatar 102 for maximization/optimization of the length and quality of life of the subject. The role of the intelligent artificial agent 104 is to integrate and analyze the available information and to define a holistic health management plan 108 for the subject. The definition of the holistic health management plan 108 by the intelligent artificial agent 104 is based on subject-specific information as well as contextual information, such as clinical guidelines and medical literature, and practical constraints, such as availability of tools and resources for implementation of the plan.

The intelligent artificial agent 104 can be trained to perform intelligent holistic management of the health of the individual using a machine learning algorithm. The intelligent artificial agent 104 performs actions based on the available data. According to an advantageous embodiment of the present invention, the intelligent artificial agent 104 can be trained to learn policies that map between world states, such as a sequence of health states of the individual, and actions used to generate the holistic health management plan 108. Different strategies for policy learning for artificial agents include learning by experience (reinforcement learning) and learning from demonstration (LfD). According to an advantageous implementation, in order to train the intelligent artificial agent 104, learning from demonstration can be implemented with a human expert executing the agent's task for one or more example cases, thus providing the “ground truth” solution that is used to train the intelligent artificial agent 104. This allows the intelligent artificial agent 104 to capture the expert's knowledge during training so that the trained intelligent artificial agent 104 can then use the learned policy to intelligently apply the expert's knowledge in generating and updating the holistic health management plan 108 for an individual given the health state of the individual. In another possible implementation, the agent can run virtual scenarios provided by a generative model, and experts' knowledge can be gathered as ground truth by recording the choices that interviewed human experts would implement in the given scenario.

In an advantageous embodiment, the intelligent artificial agent 104 can be implemented using a deep learning architecture or deep neural network (DNN). The use of a deep learning architecture can provide a performance advantage in learning complex policies over shallow machine learning algorithms, at the price of requiring more difficult training strategies. In an advantageous implementation, curriculum learning can be used to train a DNN for the intelligent artificial agent 104 based on the training examples by applying a sequence of training criteria with increasing complexity. For example, curriculum learning can be applied to train a DNN for intelligent artificial agent 104 by training the DNN/artificial agent 104 to first learn a set of actions that maximize a global measurement of positive outcome for the patient (e.g., irrespective of cost and time efficiency), and then training the DNN/artificial agent 104 to learn actions that optimize a more complex objective (e.g., including time and cost efficiency, quality of life, etc.).

In an advantageous embodiment, information from the common knowledge database 110 can be used to continuously train the intelligent artificial agent 104 or update the training of the intelligent artificial agent 104 at specified time interval (e.g., every n days). By retrospectively analyzing large sets of patient-specific medical data stored in the common knowledge database 110 and the corresponding outcomes and/or clinical history of the patients, the intelligent artificial agent 104 can learn what types of management plans were implemented and what actions led to optimal results (e.g., in terms of outcome, time efficiency, or cost efficiency). In simulated clinical studies, the intelligent artificial agent 104 can learn what different management plans would have a better performance (e.g., different therapeutic choices, surgical vs. non-surgical) given the available clinical question and the medical data.

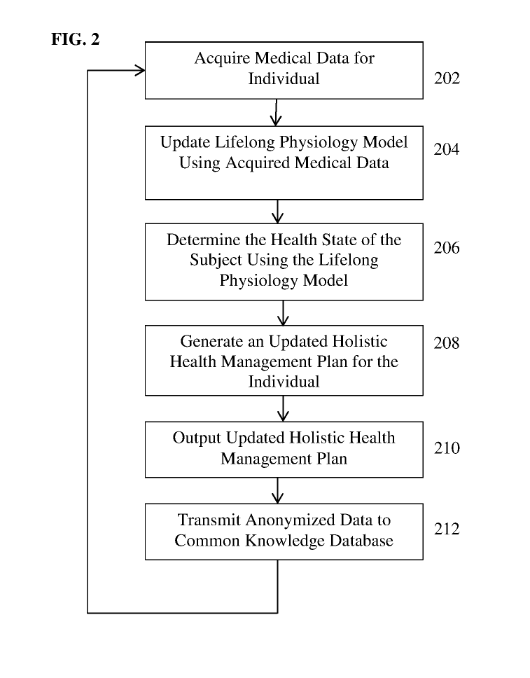

FIG. 2 illustrates a method of automated intelligent holistic management of the health of an individual according to an advantageous embodiment of the present invention. At step 202, medical data of the individual is acquired from one or more of the medical data sources 106. The medical data can include physiological measurements of the individual, medical images of the individual, medical report information, clinical history, laboratory diagnostics data, such as blood test results and molecular measurements, and/or other types of medical information about the individual. The medical data can be acquired in response to a request triggered by the intelligent artificial agent 104 or in response to an independent medical data acquisition event.

At step 204, the lifelong physiology model 104 is updated using the acquired medical data. The lifelong physiology model 104 may include a plurality of individual computational models corresponding to different aspects of the individual's physiology and pathology. These individual computational models include subject-specific parameters that are personalized for the individual based on subject specific medical data. As new subject-specific medical data for the individual is acquired, the parameters of the individual computational models can be adjusted to personalize the models based on the newly acquired medical data. In an advantageous implementation, default population based parameters can be used for computational models for which relevant medical data necessary to personalize the model parameters has not yet been acquired, and the default model parameters can be replaced with personalized parameters when the necessary medical data is acquired.

At step 206, the health state of the individual is determined using the lifelong physiology model 102. Once the lifelong physiology model 102 is updated based on the newly acquired medical data, simulations of physiology and/or pathology of the individual are performed using one or more of the collection of computational physiology models of the updated lifelong physiology model 102. The intelligent artificial agent 104 manages the evaluation process for determining the health state of the individual and controls the lifelong physiology model 102 to perform the simulations necessary to compute the current health state of the individual. Health parameters and/or disease markers (disease risk factors) are predicted based on the simulations performing using the lifelong physiology model 102. The health state of the individual can be defined based on the health parameters and/or disease markers predicted by the lifelong physiology model 102 and selected based on prior medical knowledge. For example, physiological parameters that are used in clinical practice to assess the function of a particular physiology or to assess disease progression or risk can be selected as the health parameters and/or disease markers that define the health state of the individual. Alternatively, the health state of the individual can be assessed by comparison of with the health states of similar individuals with data stored in the common knowledge database 110. The comparison can be performed on the basis of the physiological parameters predicted from the lifelong physiology model 102 for the individual. The comparison may also consider additional information about the individuals, such as age, gender, height, weight, body mass index (BMI), etc.

At step 208, an updated holistic health management plan 108 is generated for the individual based on the current health state of the individual. The intelligent artificial agent 104 controls the generation of the updated holistic health management plan 108. The intelligent artificial agent 104 may utilize a trained machine learning based model to generate the updated holistic health management plan 108 based on the current health state of the individual. For example, the intelligent artificial agent 104 may be trained (e.g., using reinforcement learning or learning by demonstration) to learn a policy for mapping the health state of an individual to actions and may generate the directives in the holistic health management plan 108 by selecting optimal actions based on the current health state of the individual. In a possible implementation, the intelligent artificial agent 104 may select actions for generating the holistic health management plan 108 using a trained deep learning architecture trained using curriculum learning with training criteria of increasing complexity.

At step 210, the updated holistic health management plan 108 is output. For example, the updated holistic health management plan 108 can be displayed on a display of a user device, such as mobile device or personal computer of the individual for whom the updated holistic health management plan 108 is generated, or displayed on the display of any other computer device. If the method is being performed on a device other than a user device, the updated holistic health management plan 108 may be output by transmitting or downloading the updated holistic health management plan 108 to a user device. In addition to displaying the updated holistic health management plan 108, the user device may output the plan in an audio format by reading the directives in the updated holistic health management plan 108 to the individual. The user device may also request the acquisition of medical data from one or more medical data sources 106 according to directives in the updated holistic health management plan 108 and provide reminders for actions mandated by the updated holistic health management plan 108.

At step 212, anonymized data of the individual is transmitted to the common knowledge database 110. The data transmitted to the common knowledge database 110 can include the acquired medical data, the health parameters predicted by the lifelong physiology model 102, the holistic health management plan 108, and any health outcomes. This data is anonymized by removing any information identifying the specific individual from the data prior to transmitting the data to the common knowledge database 110. Similar data is continuously received and stored at the common knowledge database 110 from a plurality of other individuals as well. In an advantageous embodiment, the intelligent artificial agent 104 is continuously trained (or re-trained) based on the data stored in the common knowledge database 110 from the population of individuals. For example, the intelligent artificial agent 104 can be re-trained at regular specified time intervals by analysis of health outcomes in the database or by analysis of simulated clinical studies.

The method of FIG. 2 then returns to step 202 and repeats each time new medical data is acquired for the individual.

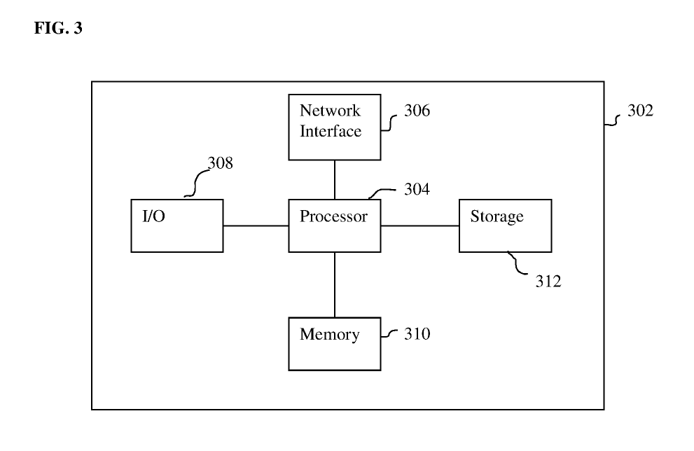

The above-described methods may be implemented on one or multiple computers using well-known computer processors, memory units, storage devices, computer software, and other components. A high-level block diagram of such a computer is illustrated in FIG. 3. Computer 302 contains a processor 304, which controls the overall operation of the computer 302 by executing computer program instructions which define such operation. The computer program instructions may be stored in a storage device 312 (e.g., magnetic disk) and loaded into memory 310 when execution of the computer program instructions is desired. Thus, the steps of the methods of FIG. 2 may be defined by the computer program instructions stored in the memory 310 and/or storage 312 and controlled by the processor 304 executing the computer program instructions. The computer 302 also includes one or more network interfaces 306 for communicating with other devices via a network. The computer 302 also includes other input/output devices 308 that enable user interaction with the computer 302 (e.g., display, keyboard, mouse, speakers, buttons, etc.). One skilled in the art will recognize that an implementation of an actual computer could contain other components as well, and that FIG. 3 is a high level representation of some of the components of such a computer for illustrative purposes.

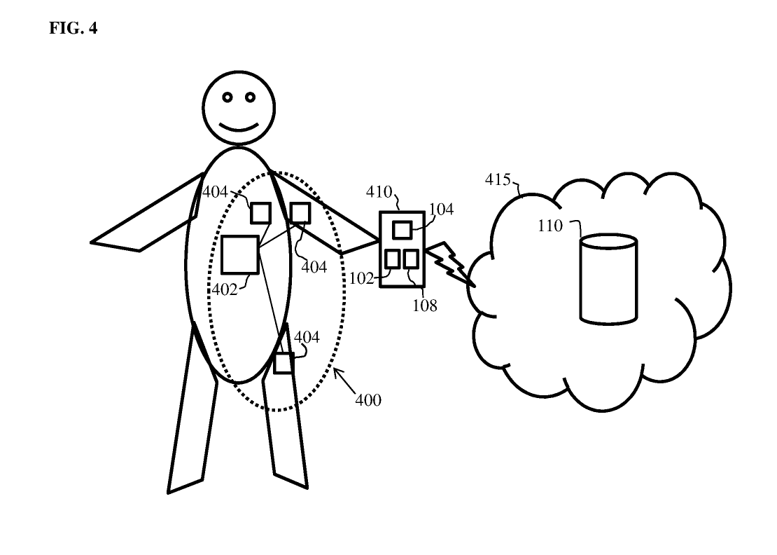

In one embodiment, the system of FIG. 1 can be run on a mobile device, such as a smart phone or tablet and combined with wearable sensors for online processing of acquired physiological data. FIG. 4 illustrates a system for holistic management of the health of an individual on a mobile device according to an embodiment of the present invention. As shown in FIG. 4, the intelligent artificial agent 104 and the lifelong physiology model 102 are both run on an individual's mobile device 410, and the holistic health management plan 108 is stored in the mobile device 410, as well. A wearable sensor network 400 is used to acquire various continuous measurements of the individual. The mobile device 410 acquires the measurements of the individual from the wearable sensor network and performs the method steps of FIG. 2. The wearable sensor network 400 can be a wearable wireless body area network (BAN), which is used to acquire data related to the person wearing the BAN and possibly the environment surrounding the person wearing the BAN. BANs are a subclass of wireless sensor networks which are employed to monitor the health and physical state of subjects. The wearable sensor network 400 of FIG. 4 includes a control unit 402 and a plurality of sensors 404. Although three sensors 404 are shown in FIG. 4, the present invention is not limited to any particular numbers of sensors. The control unit 402 can include a microprocessor to control operations of the wearable sensor network 400, a transceiver to receive data from the sensors 404 and transmit the data to the mobile device 410, and a power source (e.g., battery) to provide power to the control unit 402 and possibly to the sensors 404. The sensors 404 are placed at various locations on the patient's body and acquire continuous measurements of the patient. In an advantageous embodiment, the sensors 404 may include a heart rate sensor, one or more blood pressure sensors, an ECG sensor, and a pulse oximeter. The sensors 404 of the wearable sensor network 400 may also include other sensors, such as sensors for measuring a patient's breathing, brain activity (e.g., electroencephalography (EEG)), electromyography (EMG), skin temperature, skin conductance, electrooculography (EOG), blood pH, glucose levels, etc. The sensors 404 may also include one or more inertial sensors (e.g., accelerometers) to detect patient motion. One or more of the sensors 404 may be powered and controlled by the control unit. However, one or more of the sensors 404 may include their own power source (e.g., battery), microprocessor, and transceiver. The control unit 402 receives the patient measurements from the various sensors 404 and transmits the patient measurements to the user device 410. The control unit 402 and the sensors 404 can communicate via a wireless BAN (WBAN) communication protocol, such as IEEE.802.15.6. The control unit 402 can transmit the measurements to the mobile device 410 using a wireless communication protocol, such as Bluetooth or Zigabee, or via the WBAN communication protocol. In the embodiment of FIG. 400, the wearable sensor network 400 includes a control unit 402 that transmits all of the measurements acquired by the sensors 404 to the user device 410. However, the present invention is not limited thereto, and in an alternative embodiment, the sensors of the wearable sensor network may transmit their respective measurements directly to the user device.

In the embodiment of FIG. 4, once the intelligent agent 104 running on the individual's mobile device 410 generates the holistic health management plan 108, the intelligent agent can act as a personal assistant running on the mobile device 410 to help the individual to follow the holistic health management plan 108. For example, the intelligent artificial agent 104 can interact with the individual via the mobile device 410 in natural language to report the holistic health management plan 108 to the individual, to request the acquisition of medical data from the wearable sensor network 400 or other medical data source, and to provide reminders to the individual for actions directed by the holistic health management plan 108.

Referring again to FIG. 1, in another embodiment, the system of FIG. 1, including the intelligent artificial agent 104 and the lifelong physiology model 102, may run as a network based cloud computing system. In this case, data acquired by the medical data sources 106 (e.g., sensors, medical image acquisition devices, etc.) are sent to the cloud system for processing. The health management plan 108 can then be accessed from the cloud storage.

In another embodiment, the system of FIG. 1 may be deployed using computers in a client-server implementation, with a client computer responsible for data acquisition, a server computer receiving the acquired data and hosting the health avatar 102, and the client computer receiving the health management plan 108 as a result of the processing using the health avatar 102 hosted on the server computer.

In another embodiment, the system of FIG. 1 can be provided as a service, in which case the individual collects the data through the available medical data sources 106 and sends the data off-site for processing by one or more remote computer devices, and the health management plan 108 is sent back as a result.

In a possible embodiment, the health avatar 102, or some of its components, may include a bionic or mechatronic replica of the individual. In a possible embodiment, the virtual heart model of the health avatar 102, or some of its components, may include a clone of the individual's heart tissue based on bio-engineered tissue.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for intelligent automated holistic health management of an individual, comprising:
acquiring medical data for the individual;
updating a computational lifelong physiology model of the individual based on the acquired medical data;
determining a current health state of the individual using the updated lifelong physiology model of the individual; and
generating a holistic health management plan for the individual based on the current health state of the individual using a trained intelligent artificial agent.

2. The method of claim 1, wherein acquiring medical data for the individual comprises:
acquiring physiological measurements of the individual from one or more sensors.

3. The method of claim 1, wherein acquiring medical data for the individual comprises acquiring the medical data for the individual from one or more medical data sources including sensors for measuring physiological measurements of the patient, medical image acquisition devices, laboratory diagnostics data, medical reports, and clinical history of the individual.

4. The method of claim 1, wherein updating a computational lifelong physiology model of the individual based on the acquired medical data comprises:
updating personalized model parameters of the lifelong physiology model of the individual based on the acquired medical data.

5. The method of claim 1, wherein the lifelong physiology model of the individual comprises a plurality of individual computational physiology models, each for simulating physiology of a respective anatomical structure or a respective disease pathway, and updating a computational lifelong physiology model of the individual based on the acquired medical data comprises:
updating personalized model parameters of one or more of the plurality of individual computational physiology models.

6. The method of claim 1, wherein determining a current health state of the individual using the updated lifelong physiology model of the individual comprises:
performing simulations of the individual's physiology using the updated lifelong physiology model of the individual; and
predicting a plurality of health parameters or disease markers based on the simulations.

7. The method of claim 6, wherein determining a current health state of the individual using the updated lifelong physiology model of the individual further comprises:
comparing the predicted plurality of health parameters or disease markers to health parameters or disease markers of other individuals stored in a common knowledge database; and
determining the current health state of the individual based on the health state of other individuals with similar health parameters or disease markers.

8. The method of claim 1, further comprising:
transmitting anonymized data of the individual corresponding to the acquired medical data, health parameters simulated using the lifelong physiology model of the individual, the holistic health management plan, and health outcomes for the individual to be stored in a common knowledge database that stores data for a population of individuals.

9. The method of claim 8, further comprising:
continuously re-training the trained intelligent artificial agent based on the data for the population of individuals stored in the common knowledge database.

10. An apparatus for intelligent automated holistic health management of an individual, comprising:
means for acquiring medical data for the individual;
means for updating a computational lifelong physiology model of the individual based on the acquired medical data;
means for determining a current health state of the individual using the updated lifelong physiology model of the individual; and
means for generating a holistic health management plan for the individual based on the current health state of the individual using a trained intelligent artificial agent.

11. The apparatus of claim 10, wherein the means for updating a computational lifelong physiology model of the individual based on the acquired medical data comprises:
means for updating personalized model parameters of the lifelong physiology model of the individual based on the acquired medical data.

12. The apparatus of claim 10, wherein the lifelong physiology model of the individual comprises a plurality of individual computational physiology models, each for simulating physiology of a respective anatomical structure or a respective disease pathway, and the means for updating a computational lifelong physiology model of the individual based on the acquired medical data comprises:
means for updating personalized model parameters of one or more of the plurality of individual computational physiology models.

13. The apparatus of claim 10, wherein the means for determining a current health state of the individual using the updated lifelong physiology model of the individual comprises:
means for performing simulations of the individual's physiology using the updated lifelong physiology model of the individual; and
means for predicting a plurality of health parameters or disease markers based on the simulations.

14. The apparatus of claim 10, further comprising:
means for transmitting anonymized data of the individual corresponding to the acquired medical data, health parameters simulated using the lifelong physiology model of the individual, the holistic health management plan, and health outcomes for the individual to be stored in a common knowledge database that stores data for a population of individuals.

15. The apparatus of claim 14, further comprising:
means for continuously re-training the trained intelligent artificial agent based on the data for the population of individuals stored in the common knowledge database.

16. A non-transitory computer readable medium storing computer program instructions for intelligent automated holistic health management of an individual, the computer program instructions when executed by a processor cause the processor to perform operations comprising:
acquiring medical data for the individual;
updating a computational lifelong physiology model of the individual based on the acquired medical data;
determining a current health state of the individual using the updated lifelong physiology model of the individual; and
generating a holistic health management plan for the individual based on the current health state of the individual using a trained intelligent artificial agent.

17. The non-transitory computer readable medium of claim 16, wherein acquiring medical data for the individual comprises:
acquiring physiological measurements of the individual from one or more sensors.

18. The non-transitory computer readable medium of claim 16, wherein updating a computational lifelong physiology model of the individual based on the acquired medical data comprises:
updating personalized model parameters of the lifelong physiology model of the individual based on the acquired medical data.

19. The non-transitory computer readable medium of claim 16, wherein the lifelong physiology model of the individual comprises a plurality of individual computational physiology models, each for simulating physiology of a respective anatomical structure or a respective disease pathway, and updating a computational lifelong physiology model of the individual based on the acquired medical data comprises:
updating personalized model parameters of one or more of the plurality of individual computational physiology models.

20. The non-transitory computer readable medium of claim 16, wherein determining a current health state of the individual using the updated lifelong physiology model of the individual comprises:
performing simulations of the individual's physiology using the updated lifelong physiology model of the individual; and
predicting a plurality of health parameters or disease markers based on the simulations.

21. The non-transitory computer readable medium of claim 20, wherein determining a current health state of the individual using the updated lifelong physiology model of the individual further comprises:
comparing the predicted plurality of health parameters or disease markers to health parameters or disease markers of other individuals stored in a common knowledge database; and
determining the current health state of the individual based on the health state of other individuals with similar health parameters or disease markers.

22. The non-transitory computer readable medium of claim 16, wherein the operations further comprise:
transmitting anonymized data of the individual corresponding to the acquired medical data, health parameters simulated using the lifelong physiology model of the individual, the holistic health management plan, and health outcomes for the individual to be stored in a common knowledge database that stores data for a population of individuals.

23. The non-transitory computer readable medium of claim 22, wherein the operations further comprise:
continuously re-training the trained intelligent artificial agent based on the data for the population of individuals stored in the common knowledge database.

24. A method for training an artificial agent for intelligent automated holistic health management of an individual, comprising:
generating a plurality of training examples based on a plurality of sequences of health states of individuals by generating ground truth actions associated with each sequence of health states by recording actions performed by a human expert to generate a health management plan for the individual associated with that sequence of health states; and
training a machine learning based intelligent artificial agent based on the training examples using learning from demonstration (LfD) training to learn a policy that best maps the plurality of sequences of health states to the ground truth actions associated with each sequence of health states.
